(19) United States
(12) Patent Application Publication
(10) Pub. No.: US 2026/0252447 A1
(43) Pub. Date: Aug. 27, 2026

(54) SOLID-STATE DISK AND METHOD FOR IDENTIFYING AND FIXING AN ISSUE IN THE SOLID-STATE DISK

(71) Applicant: ATP ELECTRONICS TAIWAN INC., Taipei City (TW)

(72) Inventors: Sheng-Hsun LIN, Taipei City (TW); Pei-Yin ENG, Taipei City (TW); Roger Jia-Rong JHANG, Taipei City (TW)

(73) Assignee: ATP ELECTRONICS TAIWAN INC., Taipei City (TW)

(21) Appl. No.: 19/315,257

(22) Filed: Aug. 29, 2025

(30) Foreign Application Priority Data
Feb. 25, 2025 (TW) 114106868

(51) Int. Cl. G06F 11/14

(52) U.S. Cl. CPC G06F 11/1415; G06F 2201/805

(57) ABSTRACT

A solid-state disk (SSD) includes a power supply unit, a storage unit that stores a first program associated with implementing basic operations and a second program associated with fixing issues that occur within the SSD therein, a control unit, and a monitoring unit. The monitoring unit activates the control unit, and outputs a first control signal indicating a normal state to the control unit. The control unit, in response to receipt of the first control signal, loads and executes the first program, and outputs a pulse signal periodically. The monitoring unit, in response to determination that no pulse signal is received from the control unit, deactivates and then reactivates the control unit, and outputs a second control signal indicating an abnormal state to the control unit. The control unit, in response to receipt of the second control signal, loads and executes the second program.

### CROSS-REFERENCE TO RELATED APPLICATION

This application claims priority to Taiwanese Invention Patent Application No. 114106868, filed on Feb. 25, 2025, the entire disclosure of which is incorporated by reference herein.

### FIELD

The disclosure relates to a storage device and a maintenance method, and more particularly to a solid-state disk and a method for identifying and fixing an issue in the solid-state disk.

### BACKGROUND

Typically, electronic devices that operate with firmware (e.g., a solid-state disk (SSD)) may encounter issues during operations. For example, in the case that an algorithm contained in the firmware is faulty or that the data stored in the SSD is incorrectly stored, a larger system installed with those electronic devices may encounter abnormities or may even crash.

In the case that an issue occurs in the system, the issue may be manually identified by an operator by conducting tests and then manually fixed. When it is determined that the identified issue is attributed to a malfunction of an electronic device, the operator may need to manually remove the electronic device (which may involve desoldering), repair or replace the electronic device, and then reinstall the electronic device. Additionally, these operations may be difficult to implement when the system is located at a more remote site, such as an ocean-going vessel, an aerial vessel, polar equipment, etc.

### SUMMARY

Therefore, an object of the disclosure is to provide a solid-state disk (SSD) that is capable of for identifying and fixing an issue occurred therein.

According to the one embodiment of the disclosure, the SSD includes a power supply unit, a storage unit that stores a first program that is associated with implementing basic operations and a second program that is associated with fixing issues that occur within the SSD therein, a control unit connected to the storage unit, and a monitoring unit connected to the power supply unit and the control unit.

The monitoring unit controls the power supply unit to activate the control unit, and outputs a first control signal indicating a normal state to the control unit. The control unit, in response to receipt of the first control signal, loads and executes the first program, and outputs a pulse signal periodically. The monitoring unit, in response to determination that no pulse signal is received from the control unit, controls the power supply unit to deactivate the control unit and then to reactivate the control unit, and outputs a second control signal indicating an abnormal state to the control unit. The control unit, in response to receipt of the second control signal, loads and executes the second program to implement a self-recovery operation.

Another object of the disclosure is to provide a method or identifying and fixing an issue in a solid-state disk (SSD).

According to the one embodiment of the disclosure, the SSD includes a power supply unit, a storage unit, a control unit connected to the storage unit, and a monitoring unit connected to the power supply unit and the control unit. The storage unit stores a first program that is associated with implementing basic operations and a second program that is associated with fixing issues that occur within the SSD therein. The method includes the steps of:
(A) the monitoring unit controlling the power supply unit to activate the control unit, and outputting a first control signal indicating a normal state to the control unit;
(B) the control unit, in response to receipt of the first control signal, loading and executing the first program, and outputting a pulse signal periodically;
(C) the monitoring unit, in response to determination that no pulse signal is received from the control unit, controlling the power supply unit to deactivate the control unit and then to reactivate the control unit, and outputting a second control signal indicating an abnormal state to the control unit; and
(D) the control unit, in response to receipt of the second control signal, loading and executing the second program to implement a self-recovery operation.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a block diagram illustrating components of a solid state disk (SSD) according to one embodiment of the disclosure.

FIG. 2 is a flow chart illustrating steps implemented by a control unit of the SSD in a method for identifying and fixing an issue in the SSD according to one embodiment of the disclosure.

FIG. 3 is a flow chart illustrating steps implemented by a monitoring unit of the SSD in the method according to one embodiment of the disclosure.

FIGS. 4 and 5 illustrate signal transmission among a power supply unit, the control unit and the monitoring unit during the method according to one embodiment of the disclosure.

FIG. 6 illustrates signal transmission among the power supply unit, the control unit and the monitoring unit during a self-recovery operation of the method according to one embodiment of the disclosure.

FIG. 7 illustrates signal transmission among the power supply unit, the control unit and the monitoring unit during parts of the method according to one embodiment of the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

Throughout the disclosure, the term “coupled to” or “connected to” may refer to a direct connection among a plurality of electrical apparatus/devices/equipment via an electrically conductive material (e.g., an electrical wire), or an indirect connection between two electrical apparatus/devices/equipment via another one or more apparatus/devices/equipment, or wireless communication.

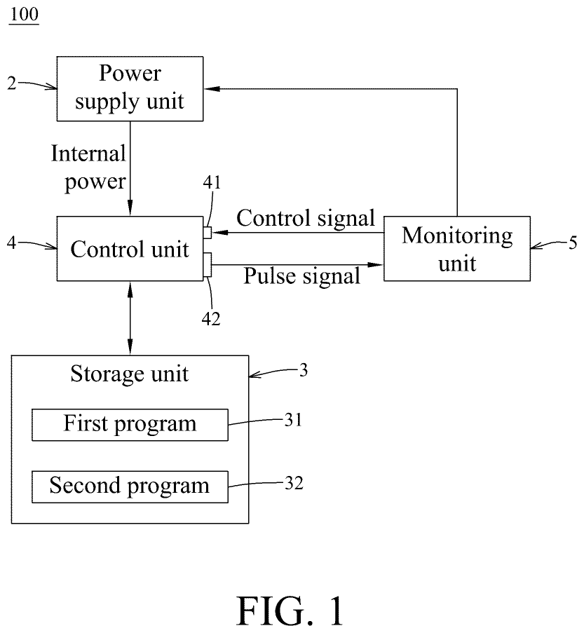

FIG. 1 is a block diagram illustrating components of a solid state disk (SSD) 100 according to one embodiment of the disclosure. In this embodiment, the SSD 100 may be a component installed in a system, and includes a power supply unit 2, a storage unit 3, a control unit 4 and a monitoring unit 5.

The power supply unit 2 may be embodied using suitable power supplies, and may include a power management integrated circuit (PMIC).

The storage unit 3 may include non-volatile memory such as NAND flash, and stores a first program 31 and a second program 32 therein. The first program 31 may be a firmware program that is configured for implementing basic operations. The second program 32 may be a fail-safe firmware program that is configured for fixing issues that occur within the SSD 100. Each of the first program 31 and the second program 32 may be constructed using in-system programming (ISP).

The control unit 4 is electrically connected to the power supply unit 2 and the storage unit 3, and operates using an internal power supplied by the power supply unit 2. In some embodiments, the control unit 4 and the storage unit 3 may be integrated within a single package, or may be in separate packages in other embodiments. It is noted that the power supply unit 2 may be controlled to supply the internal power to the control unit 4 so as to activate the control unit 4, and to cut off the internal power to the control unit 4 so as to deactivate the control unit 4.

The control unit 4 includes a communication pin 41 and a communication interface 42. It is noted that the control unit 4 may include additional components (such as a microcontroller) for implementing the operations as described below.

In some embodiments, the communication pin 41 may be embodied using a general-purpose input/output (GPIO) pin. The communication interface 42 may be embodied using an Inter-Integrated Circuit (I²C) communication bus, or other interfaces that support similar communication protocols. In the embodiment of FIG. 1, the communication pin 41 and a communication interface 42 are separately connected to the monitoring unit 5. The communication pin 41 is used for transmitting a control signal from the monitoring unit 5 to the control unit 4, and the communication interface 42 is used for transmitting a pulse signal from the control unit 4 to the monitoring unit 5. In other alternate embodiments, the control unit 4 may be configured to transmit the pulse signal via the communication pin 41, and the communication interface 42 may be used for transmitting the control signal from the monitoring unit 5 to the control unit 4. In some embodiments, the control unit 4 may include two separate communication pins 41 that are used for transmitting the control signal and the pulse signal, respectively.

In some embodiments, the control unit 4 may include only the communication pin 41, which is used for transmitting both the control signal and the pulse signal. Specifically, the monitoring unit 5 may first transmit the control signal to the control unit 4 via the communication pin 41, and in response to receipt of the control signal, the control unit 4 transmits the pulse signal via the communication pin 41 to the monitoring unit 5 periodically. In some embodiments, the control unit 4 may include only the communication interface 42, which is used for transmitting the control signal and the pulse signal. Specifically, the monitoring unit 5 may first transmit the control signal to the control unit 4 via the communication interface 42, and in response to receipt of the control signal, the control unit 4 transmits the pulse signal via the communication interface 42 to the monitoring unit 5 periodically. It is noted that in any of the above configurations, the communication pin 41 and/or the communication interface 42 may be used to transmit additional signals or information between the control unit 4 and the monitoring unit 5.

In some embodiments, the pulse signal may be in the form of a binary digital signal having a high logic voltage (e.g., the bit 1) and a low logic voltage (e.g., the bit 0). In one example, the control unit 4 may initially supply the communication pin 41 and/or the communication interface 42 with the low logic voltage. At a time instance to transmit the pulse signal, the control unit 4 shifts the voltage supplied to the communication pin 41 and/or the communication interface 42 from the low logic voltage to the high logic voltage (the operation of which may take about 10 milliseconds), continues supplying the communication pin 41 and/or the communication interface 42 with the high logic voltage for a pulse period (e.g., about 100 milliseconds), and shifts the voltage supplied to the communication pin 41 and/or the communication interface 42 from the high logic voltage to the low logic voltage (the operation of which may take about 10 milliseconds). The above operations form a complete pulse. In embodiments, the above operations may be repeated for a predetermined time period (e.g., 10 seconds) to form the complete pulse signal.

The monitoring unit 5 may be embodied using a microcontroller unit (MCU) or a monitoring MCU, and is electrically connected to the power supply unit 2 and the control unit 4, and is configured to control the power supply unit 2 to supply power to the control unit 4 or control the power supply unit 2 to cut off power supply to the control unit 4. It is worth noting that the MCU mentioned in the disclosure is not the same as the MCU typically used on a motherboard.

In some embodiments, the control signal may be in the form of a binary digital signal having the high logic voltage (e.g., the bit 1) and the low logic voltage (e.g., the bit 0). In one example, the monitoring unit 5 may initially supply the communication pin 41 and/or the communication interface 42 with the high logic voltage. At a time instance to transmit the control signal, the monitoring unit 5 controls the voltage supplied to the communication pin 41 and/or the communication interface 42 to remain the high logic voltage which indicates a normal state, or controls the voltage supplied to the communication pin 41 and/or the communication interface 42 to change to the low logic voltage which indicates an abnormal state. Typically, the control signal indicating the normal state and the control signal indicating the abnormal state are in the form of different logic voltages. That is to say, in other embodiments, the control signal indicating the normal state may be in the form of the low logic voltage, and the control signal indicating the abnormal state may be in the form of the high logic voltage.

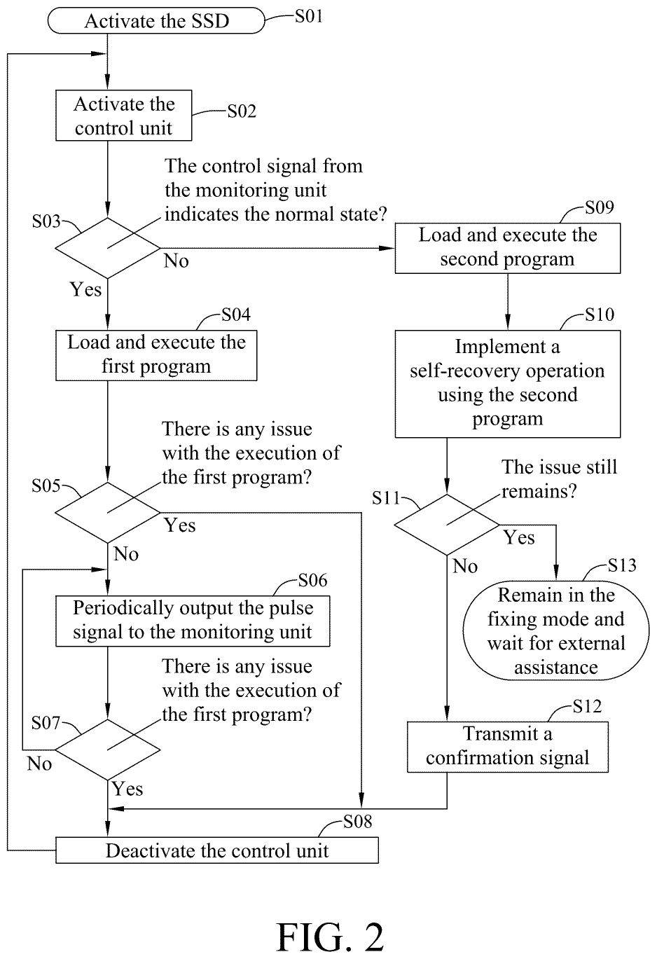

FIG. 2 is a flow chart illustrating steps implemented by the control unit 4 of the SSD 100 in a method for identifying and fixing an issue in the SSD 100 according to one embodiment of the disclosure. In the embodiment of FIG. 2, the operations are implemented using the SSD 100 of FIG. 1.

In step S01, the SSD 100 is activated. Then, in step S02, the power supply unit 2 supplies power to the control unit 4, thereby activating the control unit 4. Then, in step S03, the control unit 4 determines whether the control signal from the monitoring unit 5 indicates the normal state. In the embodiment of FIG. 2, the control signal indicating the normal state is in the form of the high logic voltage. In the case that the determination of step S03 indicates that the control signal indicates the normal state, the flow proceeds to step S04. Otherwise, in the case that determination of step S03 indicates that the control signal indicates the abnormal state, the flow proceeds to step S09.

In step S04, the control unit 4 loads and executes the first program 31 stored in the storage unit 3. Then, the flow proceeds to step S05, in which the control unit 4 determines whether there is any issue with the execution of the first program 31, such as a “failure to boot”. In the case that the determination of step S05 indicates that there is no issue with the execution of the first program 31, the flow proceeds to step S06. Otherwise, in the case that determination of step S06 indicates that there is an issue with the execution of the first program 31, the flow proceeds to step S08.

In step S06, the control unit 4 periodically outputs the pulse signal to the monitoring unit 5. In some embodiments, the control unit 4 may output the pulse signal to the monitoring unit 5 every 10 seconds. Then, the flow proceeds to step S07.

In step S07, the control unit 4 determines whether there is an issue with the execution of the first program 31 while the pulse signal is being outputted, such as a “fatal error”, an “unexpected condition”, etc. In the case that the determination of step S07 indicates that there is no issue with the execution of the first program 31, the flow goes back to step S06. Otherwise, in the case that determination of step S07 indicates that there is an issue with the execution of the first program 31 while the pulse signal is being outputted, the flow proceeds to step S08, in which the control unit 4 is deactivated. Then, the flow goes back to step S02, in which the control unit 4 is activated again.

In step S09, the control unit 4 loads and executes the second program 32 stored in the storage unit 3. Then, the flow proceeds to step S10, in which the control unit 4 implements a self-recovery operation using the second program 32 in a fixing mode. Then, in step S11, the control unit 4 determines whether the issue still remains (i.e., whether the self-recovery operation has fixed the issue). In some embodiments, the self-recovery operation may include a predetermined number of steps, and in response to successful execution of a final step, it may be determined that the self-recovery operation has fixed the issue.

In the case that the determination of step S11 indicates that the self-recovery operation has fixed the issue, the flow proceeds to step S12. Otherwise, in the case that determination of step S11 indicates that the issue still remains, the flow proceeds to step S13.

In step S12, the control unit 4 transmits a confirmation signal via the communication pin 41 and/or the communication interface 42.

In step S13, since the issue may not have been fixed using the self-recovery operation, the control unit 4 remains in the fixing mode and waits for external assistance, such as executing an external software program for fixing the issue, implementing a reset to factory operations, data recovery, reinstalling the first program 31 and/or the second program 32, etc. In some embodiments, the control unit 4 may generate and output an alert for notifying an operator of the issue in order to facilitate the external assistance.

In some embodiments, the operations related to steps S03, S04 and S09 may be implemented by the control unit 4 executing a loader program that may be stored in the storage unit 3 or in a read-only memory (ROM) included in the control unit 4.

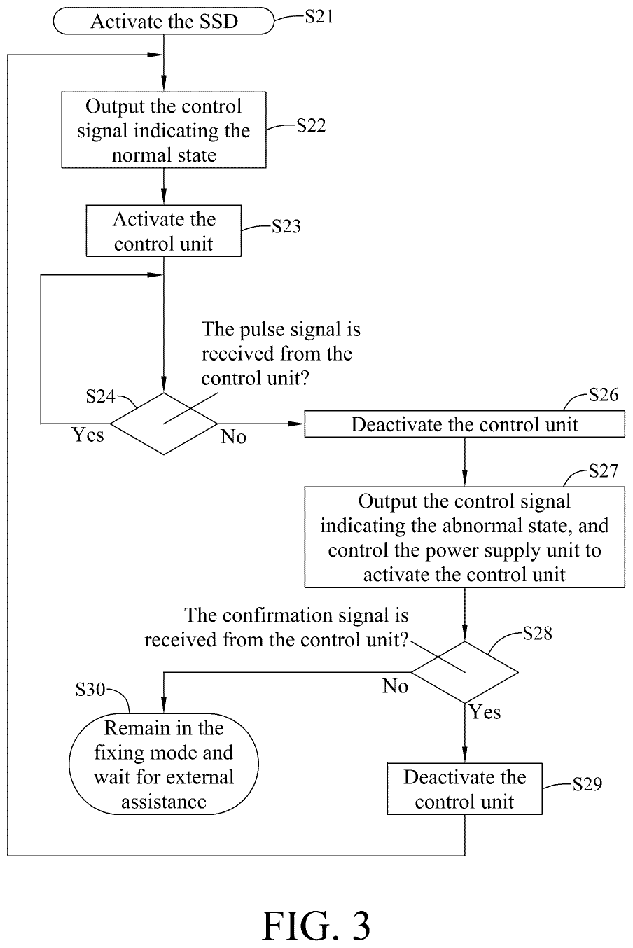

FIG. 3 is a flow chart illustrating steps implemented by the monitoring unit 5 of the SSD 100 in the method according to one embodiment of the disclosure. In the embodiment of FIG. 3, the operations are implemented using the SSD 100 of FIG. 1.

In step S21, the SSD 100 is activated. Then, in step S22, the monitoring unit 5 outputs the control signal indicating the normal state. Then, in step S23, the monitoring unit 5 controls the power supply unit 2 to activate the control unit 4. It is noted that for the sake of description, in the embodiment of FIG. 3, it is a default setting to output the control signal indicating the normal state and “assume” that the control unit 4 is functional. Additionally, the operations of steps S22 and S23 may be implemented in an arbitrary order, or may be implemented simultaneously.

In step S24, the monitoring unit 5 periodically determines whether the pulse signal is received from the control unit 4. In the case that the pulse signal is received, it is determined that the control unit 4 is not deactivated (i.e., the control unit 4 is functioning normally), and the flow goes back to step S24 to continue monitoring. Otherwise, in the case that the pulse signal is not received, the flow proceeds to step S26.

In step S26, the monitoring unit 5 controls the power supply unit 2 to deactivate the control unit 4. In step S27, the monitoring unit 5 outputs the control signal indicating the abnormal state, and controls the power supply unit 2 to activate the control unit 4. As such, after the control unit 4 is activated, the determination of step S03 may be implemented, and a determination of a control signal indicating the abnormal state causes the flow to proceed to step S09.

In step S28, the monitoring unit 5 determines whether the confirmation signal is received from the control unit 4 (meaning that recovery operation implemented in step S10 has fixed the issue). In the case that the confirmation signal is received, the flow proceeds to step S29, in which the monitoring unit 5 controls the power supply unit 2 to deactivate the control unit 4, and the flow goes back to step S22.

On the other hand, in the case that the confirmation signal is not received from the control unit 4, the flow proceeds to step S30, in which the monitoring unit 5 remains in the fixing mode and waits for external assistance. In some embodiments, the operations of step S28 may involve waiting for the confirmation signal for a predetermined time period (e.g., one minute), and in the case that no confirmation signal is received after the predetermined time period has elapsed, it may be determined that confirmation signal is not received from the control unit 4. In some alternative embodiments, the monitoring unit 5 may wait for receipt of the confirmation signal indefinitely (i.e., the flow will remain in step S28 until the confirmation signal is received).

According to one embodiment of the disclosure, there is provided a method for identifying and fixing an issue in an SSD that includes a power supply unit, a storage unit, a control unit connected to the storage unit, and a monitoring unit connected to the power supply unit and the control unit. The storage unit stores a first program and a second program therein. The method includes the steps of:
(A) the monitoring unit controlling the power supply unit to activate the control unit, and outputting a first control signal indicating a normal state to the control unit;
(B) the control unit, in response to receipt of the first control signal, loading and executing the first program, and outputting a pulse signal periodically;
(C) the monitoring unit, in response to determination that no pulse signal is received from the control unit, controlling the power supply unit to deactivate the control unit and then to reactivate the control unit, and outputting a second control signal indicating an abnormal state to the control unit;
(D) the control unit, in response to receipt of the second control signal, loading and executing the second program to implement a self-recovery operation;
(E) the control unit, in determining that the self-recovery operation has fixed the issue, transmitting a confirmation signal; and
(F) the monitoring unit, in response to receipt of the confirmation signal, controlling the power supply unit to deactivate the control unit, and repeating step (A).

In some cases, the control unit includes a communication interface that is connected to the monitoring unit and that supports a communication protocol. Step (A) includes the monitoring unit outputting the first control signal using the communication protocol through the communication interface after controlling the power supply unit to activate the control unit. Step (C) includes the monitoring unit outputting the second control signal using the communication protocol through the communication interface after controlling the power supply unit to reactivate the control unit.

In some cases, the control unit includes a communication pin connected to the monitoring unit. Step (A) includes the monitoring unit outputting the first control signal by shifting a voltage to the communication pin to a first logic level before controlling the power supply unit to activate the control unit. Step (C) includes the monitoring unit outputting the second control signal shifting the voltage to the communication pin to a second logic level different from the first logic level before controlling the power supply unit to reactivate the control unit.

In some cases, the control unit further includes a communication interface that is connected to the monitoring unit and that supports a communication protocol. Step (B) includes the control unit periodically outputting the pulse signal through the communication interface using the communication protocol.

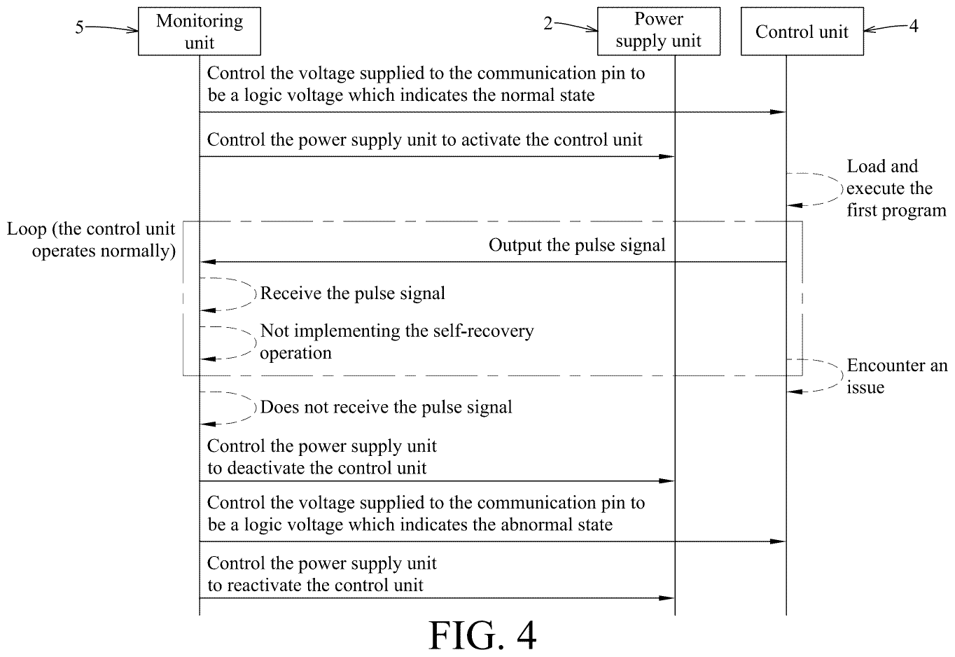

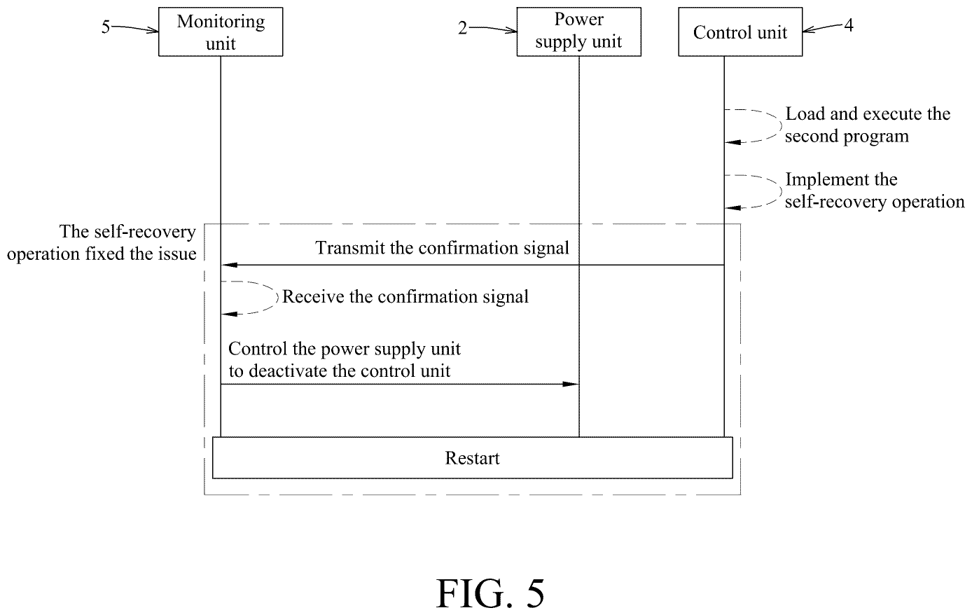

FIGS. 4 and 5 illustrate signal transmission among the power supply unit 2, the control unit 4 and the monitoring unit 5 during the method for identifying and fixing an issue in the SSD 100 according to one embodiment of the disclosure. In the embodiment of FIGS. 4 and 5, the operations are implemented using the SSD 100 of FIG. 1.

At first, the monitoring unit 5 controls the voltage supplied to the communication pin 41 to be the high logic voltage which indicates the normal state. Then, the monitoring unit 5 controls the power supply unit 2 to activate the control unit 4. In this configuration, the control signal is set slightly prior to the activation of the control unit 4. As such, as soon as the control unit 4 is activated, the control unit 4 is able to detect the precise voltage level of the communication pin 41, eliminating the possibility of the control unit 4 incorrectly detecting the control signal while the voltage supplied to the communication pin 41 is being shifted.

Then, the control unit 4, in response to receipt of the control signal, loads and executes the first program 31.

Then, the control unit 4 outputs the pulse signal periodically. In response to receipt of the pulse signal, the monitoring unit 5 continues monitoring without implementing other operations. Specifically, the monitoring unit 5 is not configured to implement the self-recovery operation. That is to say, as long as the control unit 4 is functioning normally, the above operations may be in a loop.

In the case that the control unit 4 encounters an issue, the control unit 4 may deactivate, and in the case that the pulse signal is not received, the monitoring unit 5 controls the power supply unit 2 to deactivate the control unit 4. Then, the monitoring unit 5 controls the voltage supplied to the communication pin 41 to be the low logic voltage which indicates the abnormal state, and controls the power supply unit 2 to activate the control unit 4, so as to cause the control unit 4 to load and execute the second program 32 stored in the storage unit 3, and to implement the self-recovery operation using the second program 32 in the fixing mode. Then, in the case that the self-recovery operation has fixed the issue, the control unit 4 transmits the confirmation signal to the monitoring unit 5. In response to receipt of the confirmation signal, the monitoring unit 5 controls the power supply unit 2 to deactivate the control unit 4. Afterwards, the operations may start over again.

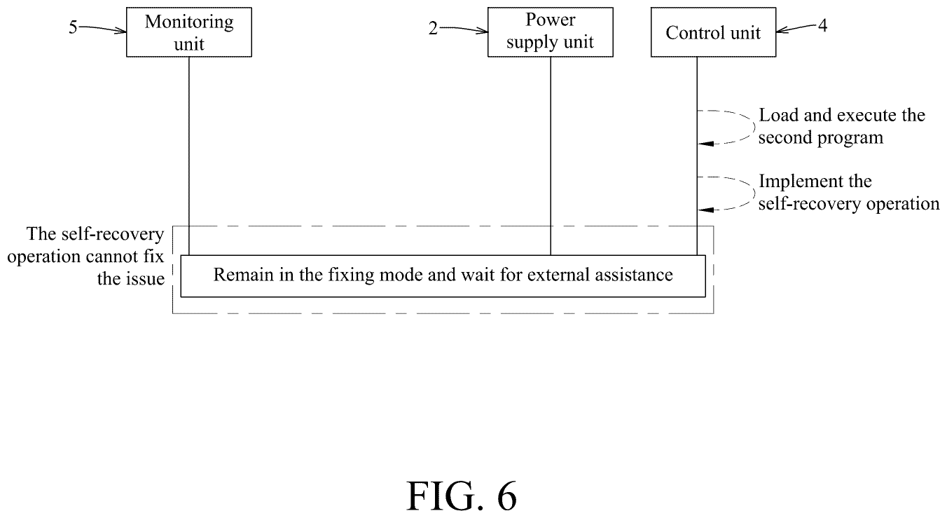

FIG. 6 illustrates signal transmission among the power supply unit 2, the control unit 4 and the monitoring unit 5 during the self-recovery operation of the method according to one embodiment of the disclosure. In the embodiment of FIG. 6, the operations are implemented using the SSD 100 of FIG. 1.

Specifically, in the case of FIG. 6, the control unit 4 loads and executes the second program 32, so as to implement the self-recovery operation in the fixing mode. In the case that the self-recovery operation fails to fix the issue, the power supply unit 2, the control unit 4 and the monitoring unit 5 may be configured to remain in the fixing mode and wait for the external solution.

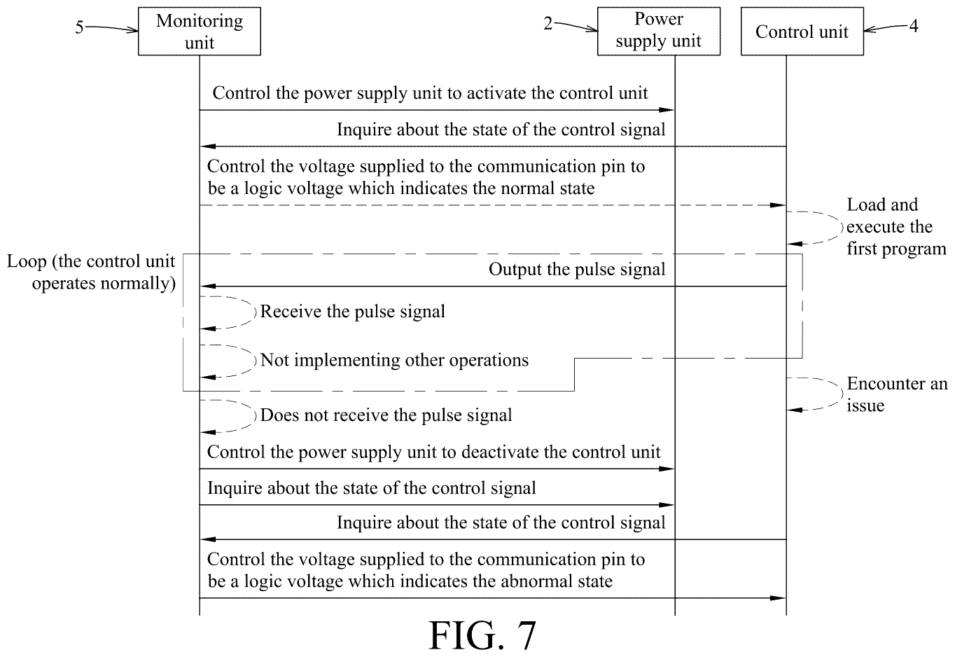

FIG. 7 illustrates signal transmission among the power supply unit 2, the control unit 4 and the monitoring unit 5 during parts of the method according to one embodiment of the disclosure. In the embodiment of FIG. 7, the operations are implemented using the SSD 100 of FIG. 1.

Specifically, the operations as shown in FIG. 7 are implemented using a communication protocol supported by the communication interface 42 (e.g., I²C). At first, the monitoring unit 5 controls the power supply unit 2 to activate the control unit 4. Upon activation, the control unit 4 may transmit an inquiry to the monitoring unit 5, inquiring about the state of the control signal. In response to receipt of the inquiry, the monitoring unit 5 outputs the control signal indicating the normal state to the control unit 4 using the communication protocol supported by the communication interface 42.

In response to receipt of the first control signal, the control unit 4 loads and executes the first program 32, and outputs the pulse signal periodically.

In response to receipt of the pulse signal, the monitoring unit 5 continues monitoring without implementing other operations. That is to say, as long as the control unit 4 is functioning normally, the above operations may be in a loop.

In the case that the control unit 4 encounters an issue, the control unit 4 may be deactivated, and in the case that the pulse signal is not received, the monitoring unit 5 controls the power supply unit 2 to deactivate the control unit 4, and then to reactivate the control unit 4.

Then, the monitoring unit 5 controls the voltage supplied to the communication pin 41 to be the low logic voltage which indicates the abnormal state, and controls the power supply unit 2 to activate the control unit 4.

Upon activation, the control unit 4 transmits another inquiry to the monitoring unit 5, inquiring about the state of the control signal. In response to receipt of the another inquiry, the monitoring unit 5 outputs the control signal indicating the abnormal state to the control unit 4 using the communication protocol supported by the communication interface 42, so as to cause the control unit 4 to load and execute the second program 32 stored in the storage unit 3, and to implement the self-recovery operation using the second program 32 in the fixing mode. The remaining operations may be carried out in a manner similar as described in FIG. 5, and details are omitted herein for the sake of brevity.

To sum up, the embodiments of the disclosure provide an SSD and a method for identifying and fixing an issue in the SSD. The SSD stores both a first program that is associated with implementing basic operations and a second program that is associated with fixing issues that occur within the SSD. The SSD includes a control unit and a monitoring unit. In the case that the monitoring unit transmits a control signal that indicates a normal state, the control unit is configured to load and execute the first program, and while the control unit is functioning normally, the control unit transmits a pulse signal periodically. In the case that the control unit encounters an issue, the control unit ceases to transmit the pulse signal, and in the case that the monitoring unit does not receive the pulse signal, the monitoring unit controls the power supply unit to deactivate the control unit, transmits a control signal that indicates an abnormal state, and controls the power supply unit to reactivate the control unit. Upon reactivating, the control unit detects the control signal that indicates the abnormal state, and loads and executes the second program to implement a self-recovery operation in order to fix the issue. As such, the SSD employs separate components to ensure that the issue may be identified and fixed, thereby increasing the robustness of the SSD and reducing the need for external solution.

Additionally, in some embodiments, the transmission of the control signal and/or the pulse signal may be done via a communication pin which may be embodied using a general-purpose input/output (GPIO) pin. In this manner, the transmission of the control signal and/or the pulse signal may be done with better quality.

Moreover, in some embodiments, the transmission of the control signal and/or the pulse signal may be done via a communication interface which may be embodied using an Inter-Integrated Circuit (I²C) communication bus, or other interfaces that support the similar communication protocols. By using the components that are commonly built in the SSD to implement the transmission of the control signal and/or the pulse signal, the method may be implemented without increasing cost on hardware components.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A solid-state disk (SSD) comprising:
a power supply unit;
a storage unit that stores a first program that is associated with implementing basic operations and a second program that is associated with fixing issues that occur within the SSD therein;
a control unit connected to the storage unit; and
a monitoring unit connected to the power supply unit and the control unit, wherein
the monitoring unit controls the power supply unit to activate the control unit, and outputs a first control signal indicating a normal state to the control unit,
the control unit, in response to receipt of the first control signal, loads and executes the first program, and outputs a pulse signal periodically,
the monitoring unit, in response to determination that no pulse signal is received from the control unit, controls the power supply unit to deactivate the control unit and then to reactivate the control unit, and outputs a second control signal indicating an abnormal state to the control unit; and
the control unit, in response to receipt of the second control signal, loads and executes the second program to implement a self-recovery operation.

2. The SSD as claimed in claim 1, wherein:
the control unit, in determining that the self-recovery operation has fixed the issue, further transmits a confirmation signal; and
the monitoring unit, in response to receipt of the confirmation signal, further controls the power supply unit to deactivate the control unit, controls the power supply unit to reactivate the control unit, and outputs the first control signal indicating the normal state to the control unit.

3. The SSD as claimed in claim 1, wherein:
the control unit includes a communication interface that is connected to the monitoring unit and that supports a communication protocol;
the monitoring unit, after controlling the power supply unit to activate the control unit, outputs the first control signal using the communication protocol; and
the monitoring unit, after controlling the power supply unit to reactivate the control unit, outputs the second control signal using the communication protocol through the communication interface.

4. The SSD as claimed in claim 1, wherein:
the control unit includes a communication pin connected to the monitoring unit;
the monitoring unit, before controlling the power supply unit to activate the control unit, outputs the first control signal by shifting a voltage to the communication pin to a first logic level; and
the monitoring unit, before controlling the power supply unit to reactivate the control unit, outputs the second control signal shifting the voltage to the communication pin to a second logic level different from the first logic level.

5. The SSD as claimed in claim 4, wherein:
the control unit further includes a communication interface that is connected to the monitoring unit and that supports a communication protocol; and
the control unit periodically outputs the pulse signal through the communication interface using the communication protocol.

6. A method for identifying and fixing an issue in a solid-state disk (SSD), the SSD including a power supply unit, a storage unit, a control unit connected to the storage unit, and a monitoring unit connected to the power supply unit and the control unit, the storage unit storing a first program that is associated with implementing basic operations and a second program that is associated with fixing issues that occur within the SSD therein, the method comprising the steps of:
(A) the monitoring unit controlling the power supply unit to activate the control unit, and outputting a first control signal indicating a normal state to the control unit;
(B) the control unit, in response to receipt of the first control signal, loading and executing the first program, and outputting a pulse signal periodically;
(C) the monitoring unit, in response to determination that no pulse signal is received from the control unit, controlling the power supply unit to deactivate the control unit and then to reactivate the control unit, and outputting a second control signal indicating an abnormal state to the control unit; and
(D) the control unit, in response to receipt of the second control signal, loading and executing the second program to implement a self-recovery operation.

7. The method as claimed in claim 6, further comprising, after step (D), the steps of:
(E) the control unit, in determining that the self-recovery operation has fixed the issue, transmitting a confirmation signal; and
(F) the monitoring unit, in response to receipt of the confirmation signal, controlling the power supply unit to deactivate the control unit, and repeating step (A).

8. The method as claimed in claim 6, the control unit including a communication interface connected to the monitoring unit and that supports a communication protocol, wherein:
step (A) includes the monitoring unit outputting the first control signal using the communication protocol after controlling the power supply unit to activate the control unit; and
step (C) includes the monitoring unit outputting the second control signal using the communication protocol through the communication interface after controlling the power supply unit to reactivate the control unit.

9. The method as claimed in claim 6, the control unit including a communication pin connected to the monitoring unit, wherein:
step (A) includes the monitoring unit outputting the first control signal by shifting a voltage to the communication pin to a first logic level before controlling the power supply unit to activate the control unit; and
step (C) includes the monitoring unit outputting the second control signal shifting the voltage to the communication pin to a second logic level different from the first logic level before controlling the power supply unit to reactivate the control unit.

10. The method as claimed in claim 9, the control unit further including a communication interface that is connected to the monitoring unit and that supports a communication protocol, wherein step (B) includes the control unit periodically outputting the pulse signal through the communication interface using the communication protocol.
